(19) United States
(12) Patent Application Publication
(10) Pub. No.: US 2026/0054659 A1
(43) Pub. Date: Feb. 26, 2026

(54) COMPONENT COVER MOUNTING ASSEMBLY

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Keisuke HARADA, Okazaki-shi (JP); Isao SHINAGAWA, Toyota-shi (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/303,493

(22) Filed: Aug. 19, 2025

(30) Foreign Application Priority Data
Aug. 21, 2024 (JP) 2024-139552

(51) Int. Cl. B60R 13/02; B60R 1/04

(52) U.S. Cl. CPC B60R 13/0212; B60R 1/04

(57) ABSTRACT

A cover mounting assembly includes a cover covering a component that is on a front window of a vehicle and a roof lining disposed on a rear side of the front window and configured as a vehicular interior side surface of a ceiling of the vehicle. The roof lining includes a mounting recessed portion that is recessed rearward from a front edge of the roof lining. The mounting recessed portion includes a first portion in which an overhead console is fitted such that the overhead console is disposed rearward away from the front edge of the roof lining, and a second portion in which a rear portion of the cover is fitted to cover a space of the second portion between the front window and the overhead console and fix the cover to the roof lining.

### CROSS REFERENCE TO RELATED APPLICATION

This application claims priority from Japanese Patent Application No. 2024-139552 filed on August 21, 2024. The entire contents of the priority application are incorporated herein by reference.

### TECHNICAL FIELD

The technology described herein relates to a component cover mounting assembly.

### BACKGROUND

Various kinds of devices such as a driving recorder, an ETC (electronic toll collection system) sensor, and a rain sensor are fixed to a vehicular interior side surface of a front glass of a vehicle such as an automobile. With such devices being uncovered and exposed to a vehicular interior space, the appearance of the vehicular interior is degraded. The devices are covered so as not to be seen from the vehicular interior side. The cover is positioned with respect to the device and the front glass and fixed to the front glass with adhesive, for instance. Or the cover may be fixed to an overhead console that is mounted on a front edge of a ceiling of a vehicle.

As described above, to fix the cover with respect to the various kinds of devices, the front glass, or the overhead console, a space is necessary between the cover and the roof lining for absorbing a tolerance. Due to the space, a sense of unity or continuity of the cover and the roof lining is less likely to be obtained. Particularly, with the kinds of devices fixed to the front window increasing, the number of covers increases and the size of the cover increases. Improvement of a design of the vehicular interior has been demanded.

### SUMMARY

An object of the technology described herein is to provide a component cover mounting assembly that provides a sense of unity and continuity of a cover and a roof lining.

A cover mounting assembly according to the technology described herein includes a cover covering a component that is on a front window of a vehicle and a roof lining disposed on a rear side of the front window and configured as a vehicular interior side surface of a ceiling of the vehicle. The roof lining includes a mounting recessed portion that is recessed rearward from a front edge of the roof lining. The mounting recessed portion includes a first portion in which an overhead console is fitted such that the overhead console is disposed rearward away from the front edge of the roof lining and a second portion in which a rear portion of the cover is fitted to cover a space defined by the second portion between the front window and the overhead console and fix the cover to the roof lining.

### BRIEF DESCRIPTION OF THE DRAWINGS

FIG. 1 is a perspective view of a front window of a vehicle and a front portion of a roof lining according to one embodiment seen from a vehicular exterior side.

FIG. 2 is an exploded perspective view of FIG. 1.

FIG. 3 is a perspective view of the front window of the vehicle and a front portion of a ceiling seen from a vehicular interior side.

FIG. 4 is a perspective view of a cover mounting assembly according to one embodiment.

FIG. 5 is an enlarged perspective view of the front window and the front portion of the roof lining seen from a vehicular interior rear side.

FIG. 6 is a bottom view of the front window and the front portion of the ceiling.

FIG. 7 is an exploded view of the roof lining.

FIG. 8 is a cross-sectional view of a front portion of the ceiling.

FIG. 9 is an exploded view of the cover mounting assembly.

FIG. 10 is a perspective view of the cover mounting assembly.

FIG. 11 is a perspective view of a front portion of the ceiling.

FIG. 12 is a cross-sectional view of a front portion of the ceiling.

FIG. 13 is a perspective view of a camera module.

FIG. 14 is a side view of a front portion of the ceiling.

FIG. 15 is a cross-sectional view taken along line XV-XV in FIG. 6.

FIG. 16 is a cross-sectional view of a cover.

### DETAILED DESCRIPTION

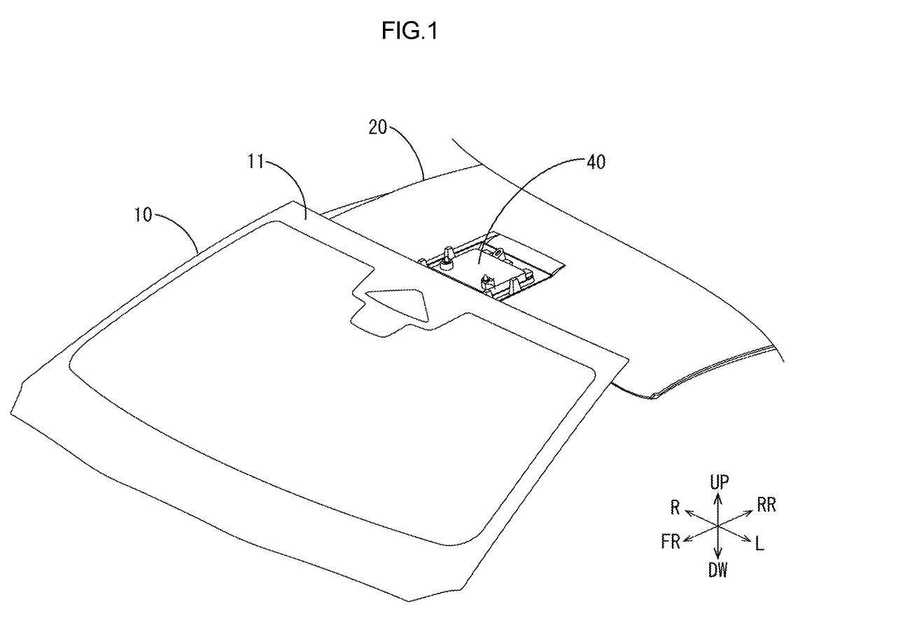

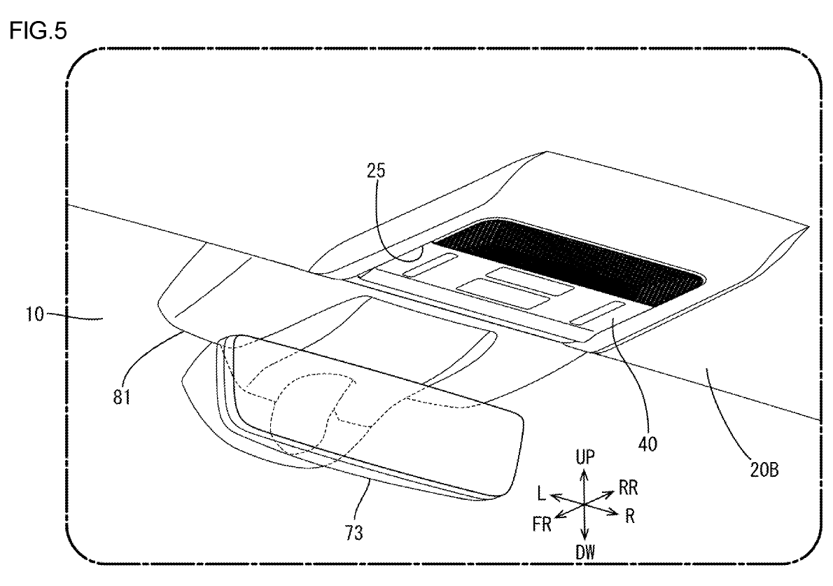

One embodiment of a cover mounting assembly 1 will be described with reference to FIGS. 1 to 16. In each of the drawings, arrows FR and RR represent a vehicular front side (a vehicular forward moving direction) and a vehicular rear side, respectively, arrows R and L represent a right side and a left side with respect to the forward moving direction, respectively, and arrows UP and DW represent an upper side and a bottom side, respectively.

With reference to FIG. 1, a front window 10 is disposed in front of a driver’s seat and a passenger’s seat and has an inclined surface that is inclined rear-upward as it extends rearward from the front side. A roof lining 20 is disposed on the rear side of the front window 10 and is disposed behind the upper edge of the front window 10. The roof lining 20 is configured as a vehicular interior ceiling of the vehicle. The roof lining 20 includes a roof lining body 20A and a reinforcing member 30.

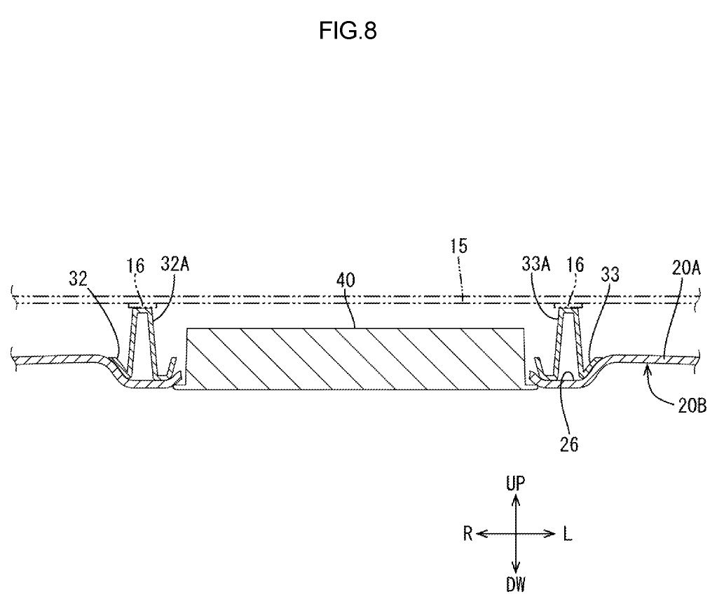

The roof lining body 20A as a whole has a plate shape that covers a vehicular interior side surface of a roof panel 15 of a vehicle body (refer to FIG. 8). The roof lining body 20A horizontally extends. The plate surface of the roof lining body 20A is spaced from the roof panel 15. The lower surface of the roof lining body 20A faces the vehicular interior side and is configured as a design surface 20B.

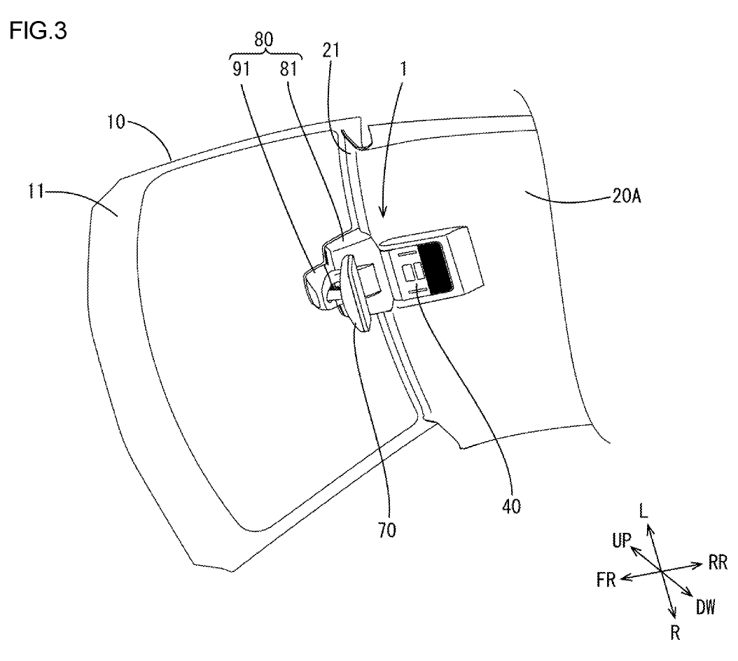

As illustrated in FIGS. 3 to 5, an overhead console 40 is fitted in a front middle section of the roof lining body 20A with respect to a vehicular width direction. Various kinds of electric components such as a map lamp and various kinds of switches such as a map lamp switch are mounted on the overhead console 40.

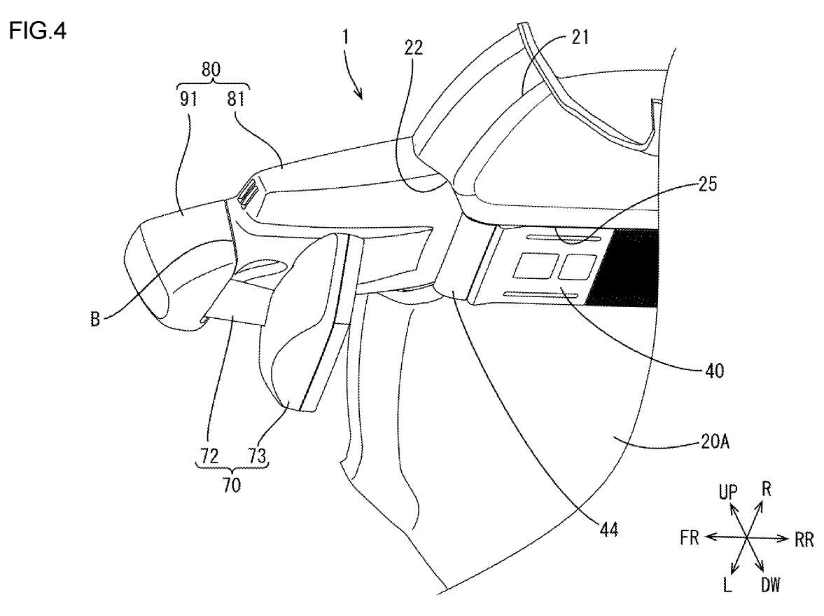

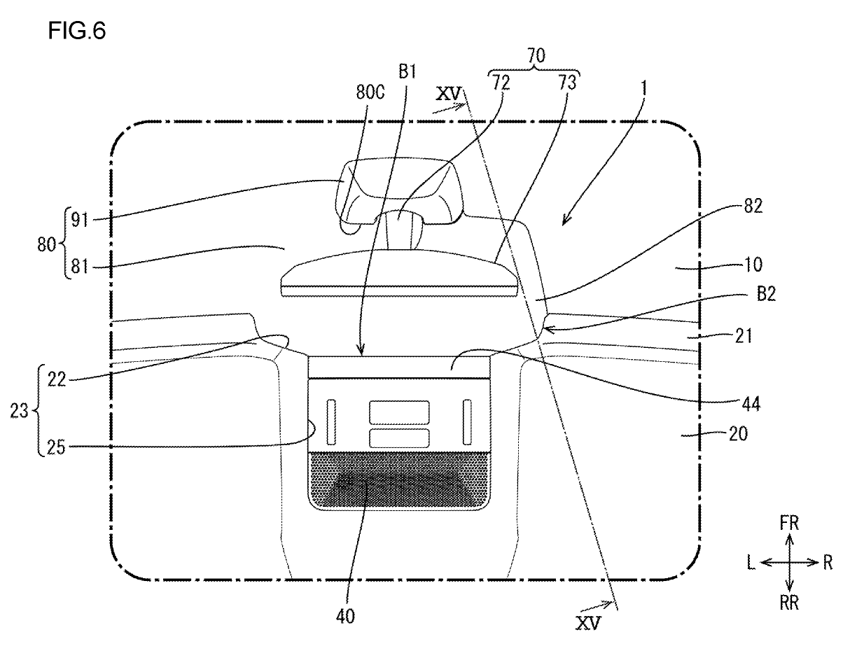

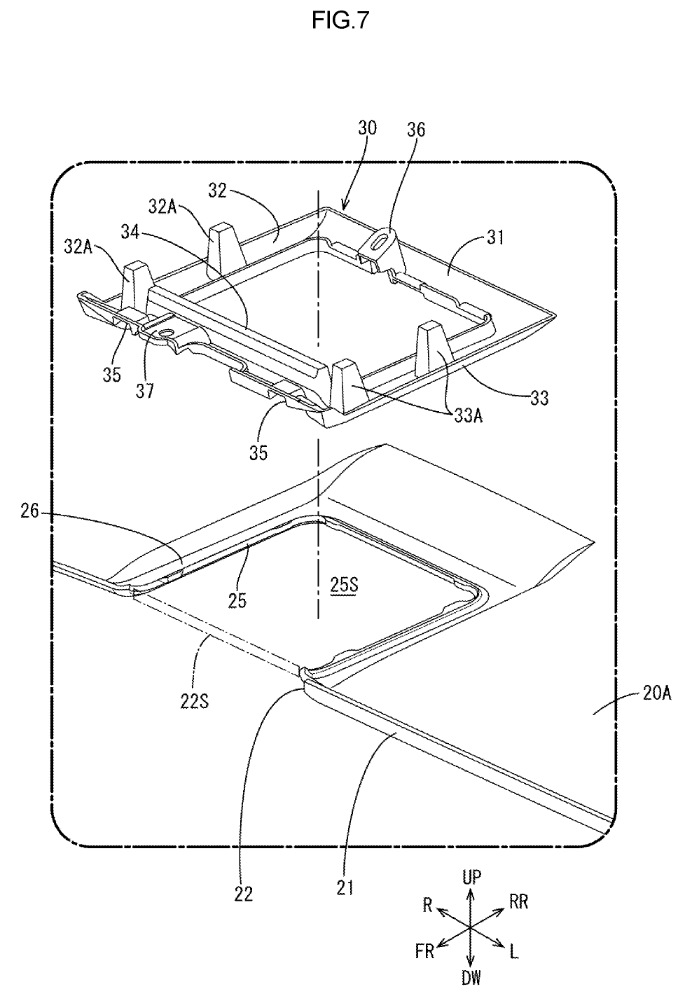

Specifically, as illustrated in FIG. 4, the roof lining body 20A of the roof lining 20 includes a wall portion 21 (one example of a bent portion) at a front edge portion. The roof lining body 20A has a plate shape horizontally extending opposite the roof panel 15. The front edge portion of the roof lining 20 is bent upward and configured as the wall portion 21. The wall portion 21 is bent obliquely upward and frontward. The wall portion 21 extends in the vehicular width direction and has a length that is same as the width of the roof lining 20 measured in the vehicular width direction. As illustrated in FIGS. 4 and 6, the roof lining 20 includes a first mounting recess portion 22 (one example of a second portion of a mounting recessed portion) in a middle of the wall portion 21 with respect to the vehicular width direction. The first mounting recess portion 22 is recessed rearward from a front edge of the wall portion 21 and has an arched shape. The first mounting recess portion 22 has a space 22S therein (refer to FIG. 7). A portion of a cover 80 (one example of a cover) is mounted in the space 22S of the first mounting recess portion 22. A recessed dimension of the first mounting recess portion 22 is slightly smaller than the height of the wall portion 21.

The roof lining 20 further includes a second mounting recess portion 25 (one example of a first portion of the mounting recessed portion) that is further recessed rearward from the first mounting recess portion 22. The second mounting recess portion 25 is in a middle of the roof lining 20 in the vehicular width direction. The second mounting recess portion 25 has a space 25S therein and the overhead console 40 is mounted in the space 25S of the second mounting recess portion 25. The width dimension of the second mounting recess portion 25 is smaller than the width dimension of the first mounting recess portion 22. As illustrated in FIG. 6, the first mounting recess portion 22 and the second mounting recess portion 25 are continuous to each other and configured as a mounting recessed portion 23. The mounting recessed portion 23 has a substantially T shape.

As illustrated in FIGS. 7 and 8, the roof lining body 20A includes a recess 26 that extends along an inner peripheral edge portion of the second mounting recess portion 25. The recess 26 is a shallow groove and recessed downward. The recces 26 is a U-shaped groove. The recess 26 is for receiving the reinforcing member 30 (one example of a reinforcing portion) that reinforces the second mounting recess portion 25.

As illustrated in FIGS. 7 to 9, the reinforcing member 30 has a rectangular frame shape and a portion of the reinforcing member 30 is disposed in the recess 26. Specifically, the reinforcing member 30 includes a rear portion 31, a right portion 32, a left portion 33, and a front portion 34 (one example of a bridging portion) that form the rectangular frame shape. The rear portion 31 is disposed in a rear portion of the U-shaped recess 26 extending in the vehicular width direction. The right portion 32 is disposed in a right portion of the U-shaped recess 26 extending in the front-rear direction. The left portion 33 is disposed in a left portion of the U-shaped recess 26 extending in the front-rear direction. The front portion 34 extends in the vehicular width direction so as to extend from a front end portion of the right portion 32 to a front end portion of the left portion 33. The front portion 34 extends to bridge a space between the front ends of the U-shaped second mounting recess portion 25.

The right portion 32 includes projections 32A and the left portion 33 includes projections 33A. The projections 32A, 33A project toward the roof panel 15. As illustrated in FIG. 8, projecting ends of the projections 32A, 33A are contacted with the roof panel 15 with having a cushioning member 16 between the projecting ends and the roof panel 15. Thus, the roof lining 20 is less likely to be deformed upward.

As illustrated in FIG. 8, an inner dimension between two opposite inner peripheral edges of the frame-shaped reinforcing member 30 is determined such that the inner peripheral portion of the reinforcing member 30 is just fitted to an outer peripheral wall of the recess 26 with the reinforcing member 30 being arranged in the recess 26. An outer dimension between two opposite outer peripheral edges of the reinforcing member 30 is determined such that the outer peripheral portion of the reinforcing member 30 is just fitted to an inner peripheral wall of the recess 26 with the reinforcing member 30 being arranged in the recess 26. With such a configuration, the reinforcing member 30 is positioned with respect to the roof lining body 20A. The reinforcing member 30 is bonded to a vehicular exterior side surface of the roof lining body 20A with adhesive with being fitted in the recess 26. Thus, the reinforcing member 30 is included integrally with the roof lining body 20A and configured as the roof lining 20.

As illustrated in FIG. 7, the front portion 34 of the reinforcing member 30 includes a fixing portion 37 with which the roof lining 20 is fixed to the roof panel 15 via the reinforcing member 30 with a clip or a screw. The rear portion 31 of the reinforcing member 30 includes a holding portion 36 for holding lines that are connected to various kinds of electric components and switches of the overhead console 40. The holding portion 36 projects upward.

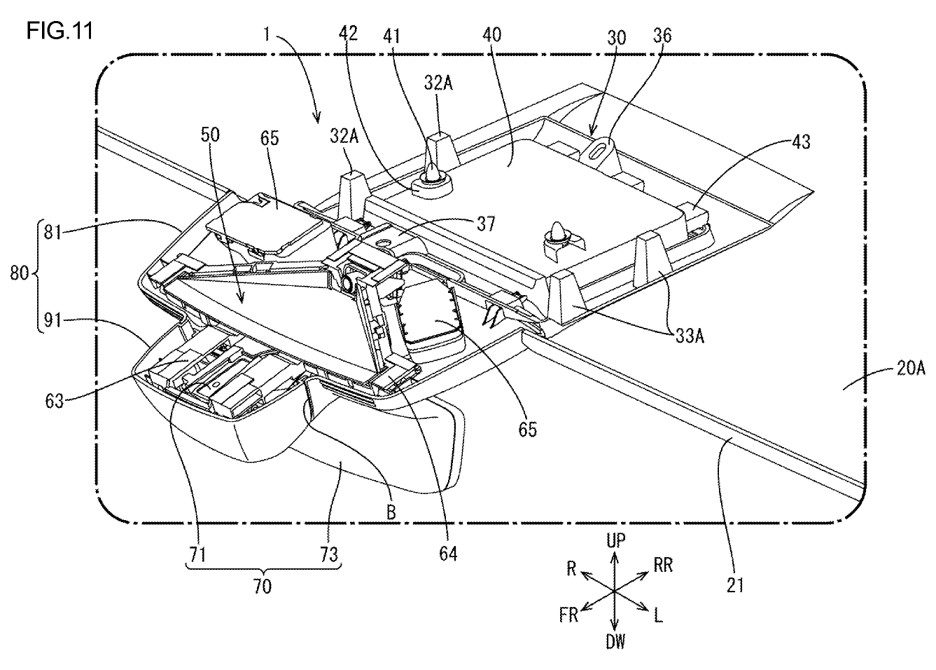

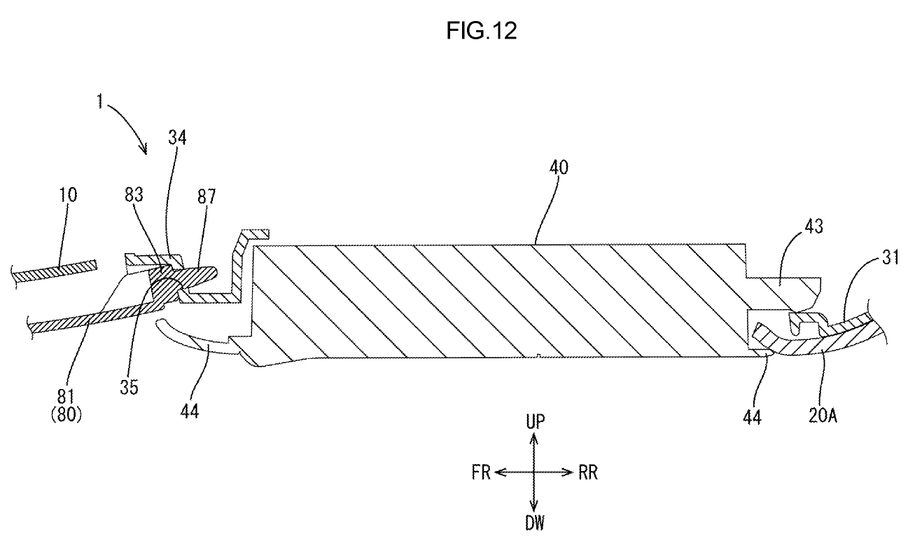

The overhead console 40 has a rectangular flat box shape so as to be fitted in the inner space 25S of the second mounting recess portion 25 and the reinforcing member 30. As illustrated in FIG. 11, the overhead console 40 includes a clip seat 42 on an upper surface and a clip 41 is attached to the clip seat 42. The overhead console 40 is fixed to a vehicular body with the clip 41. The overhead console 40 includes three stopper pieces 43 that project rearward from a rear surface of the overhead console 40. The three stopper pieces 43 are arranged in the vehicular width direction. With the overhead console 40 being fitted in the inner space 25S of the second mounting recess portion 25 of the roof lining 20 and the reinforcing member 30, the stopper pieces 43 are contacted with the upper surface of the rear portion 31 of the reinforcing member 30 as illustrated in FIG. 12 such that the overhead console 40 is less likely to fall.

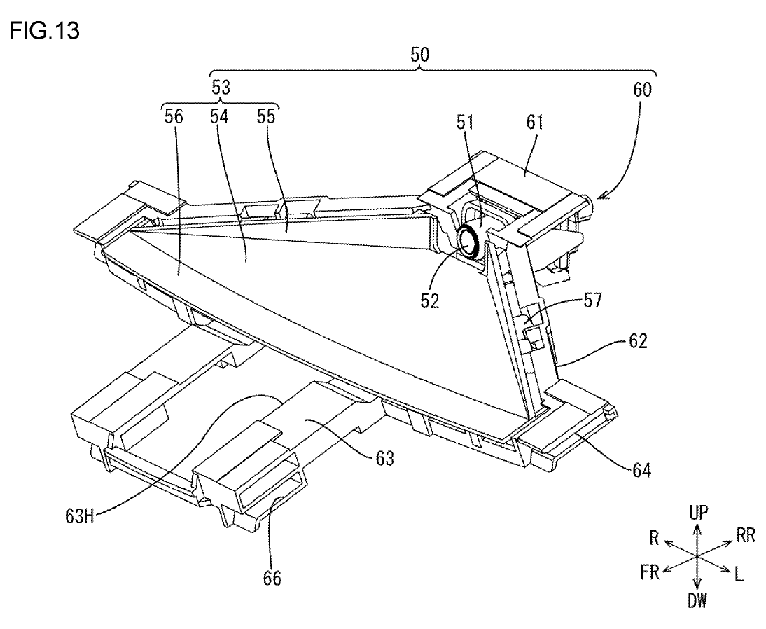

As illustrated in FIG. 11, a camera module 50 is mounted on a vehicular interior side of an upper middle portion of the front window 10 with respect to the vehicular width direction. The camera module 50 is mounted in front of the overhead console 40. As illustrated in FIG. 13, the camera module 50 includes a camera body 51, an angle of view protection plate (an AOV protection plate) 53, and a holding member 60. The camera body 51 is arranged with a lens 52 facing frontward.

As illustrated in FIG. 13, the AOV protection plate 53 includes a bottom 54, walls 55, and an extending portion 56. The bottom 54 is a plate member having a flat isosceles triangle plan view shape. The bottom 54 extends in a substantially horizontal direction such that a vertex of the isosceles triangular shaped bottom 54 is disposed below and in front of the lens 52 and a bottom edge of the isosceles triangular shaped bottom 54 is on the vehicular front side. Namely, the bottom 54 spreads such that a width measured in a right-left direction increases as the bottom 54 extends frontward.

The walls 55 extends upward from two side edges of the isosceles triangular shaped bottom 54. An angle between the two walls 55 is almost same as an angle of view of the camera. The extending portion 56 extends frontward and slightly downward from the bottom edge of the isosceles triangular shaped bottom 54. The bottom 54 extends horizontally; however, upper surfaces of the two walls 55 and an upper surface of the extending portion 56 extend along the surface of the front window 10. The upper surfaces of the walls 55 and the extending portion 56 are inclined at an inclination angle same as the inclination angle of the front window 10.

The holding member 60 holds the camera body 51 and the AOV protection plate 53 in a correct position and a correct posture with respect to the front window 10. The holding member 60 includes a camera holder 61 and a protection plate holder 62. The camera holder 61 holds the camera body 51. The protection plate holder 62 holds the AOV protection plate 53. The protection plate holder 62 has an isosceles triangular frame shape and extends from the camera holder 61 frontward and spreads in the right-left direction. The protection plate holder 62 holds the two walls 55 of the AOV protection plate 53 with fitting portions 57 of the walls 55 being fitted to fitting portions of the protection plate holder 62 and also supports the extending portion 56 of the AOV protection plate 53 from a lower side. The holding member 60 further includes a cover holder 64 that extends in the vehicular width direction from bottom edge-side corners of the protection plate holder 62. The cover holder 64 holds a cover 80.

The holding member 60 includes a mirror fitting portion 63 that extends frontward from the front section of the protection plate holder 62 along the surface of the front window 10.

The camera module 50 is fixed to the front window 10 with the camera body 51 and the AOV protection plate 53 being held by the holding member 60. The camera module 50 is fixed to the front window 10 with an upper surface of the camera holder 61 of the holding member 60, a portion of an upper surface of the protection plate holder 62 extending along the walls 55, upper end surfaces of the walls 55 of the AOV protection plate 53, an upper surface of the extending portion 56, and a portion of an upper surface of the mirror fitting portion 63 being bonded to the vehicular interior side surface of the front window 10 with adhesive.

As illustrated in FIG. 11, electric components 65 such as an ETC sensor and a thermometer are bonded and fixed to the vehicular interior side surface of the front window 10 on the right and left sides of the camera body 51 (the camera holder 61). A rear mirror 70 is bonded and fixed to the vehicular interior side surface of the front window 10 on the front side of the AOV protection plate 53.

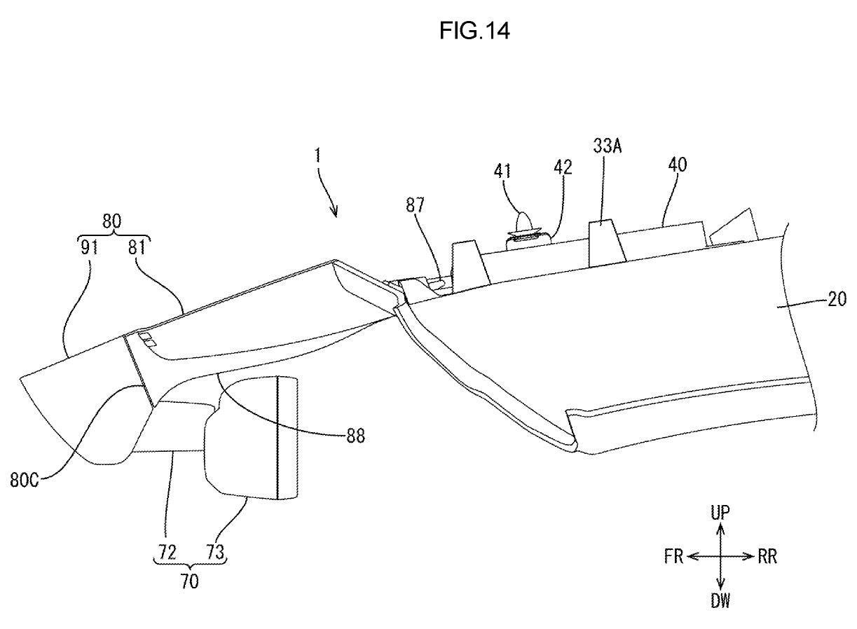

As illustrated in FIGS. 11 and 14, the rear mirror 70 includes a base portion 71, a neck portion 72, and a mirror body 73. The base portion 71 is bonded to the vehicular interior side surface of the front window 10. The neck portion 72 is attached to the base portion 71. The mirror body 73 is attached to a distal end portion of the neck portion 72 so as to be rotatable and has an elongated shape extending in the vehicular width direction. As illustrated in FIGS. 11 and 13, the mirror fitting portion 63 of the holding member 60 has a U shape and has an insertion hole 63H through which the base portion 71 and the neck portion 72 of the rear mirror 70 can be inserted from the lower side. The mirror fitting portion 63 extends frontward from the front section of the protection plate holder 62 along the surface of the front window 10.

This embodiment includes a cover 80 that collectively covers the camera module 50, the electric components 65, and the base portion 71 of the rear mirror 70 that are fixed to the front window 10.

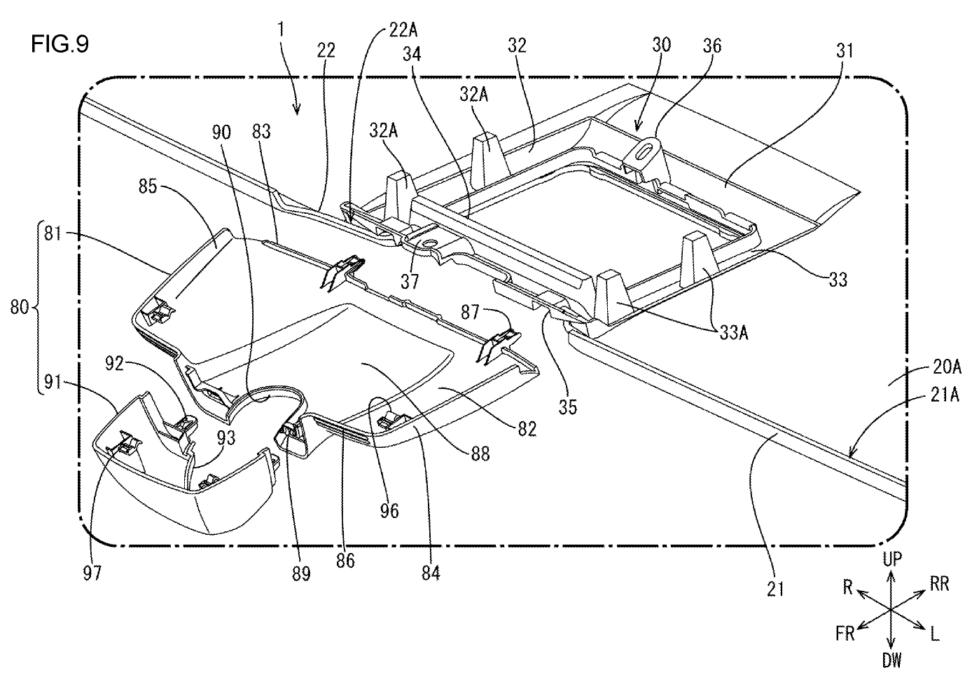

As illustrated in FIGS. 9, 10, and 14, the cover 80 of this embodiment includes a rear cover portion 81 and a front cover portion 91. The rear cover portion 81 is disposed in front of the overhead console 40 that is arranged away from the front edge of the roof lining 20. The rear cover portion 81 collectively covers the protection plate holder 62 of the camera module 50 and the electric components 65. The front cover portion 91 is connected to the rear cover portion 81 on the front side and collectively covers the mirror fitting portion 63 of the camera module 50 and the base portion 71 of the rear mirror 70. The rear cover portion 81 and the front cover portion 91 are fitted together and configured as the cover 80. The cover 80 is configured to be able to be divided into two pieces in the front-rear direction.

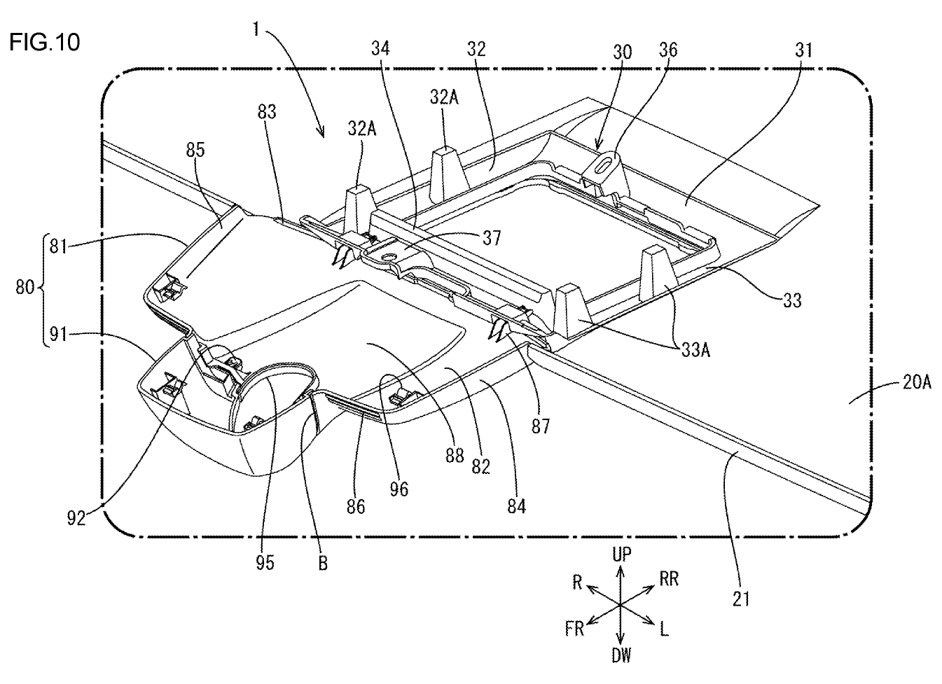

As illustrated in FIGS. 9 and 10, the rear cover portion 81 has a laterally long rectangular shallow plate shape as a whole. Specifically, the rear cover portion 81 includes a bottom 82, a reinforcing rib 83, a left wall 84 and a right wall 85, and a front wall 86. The bottom 82 is a rectangular plate member and covers the camera module 50 except for the mirror fitting portion 63 and the electric components 65 from the vehicular interior side. The reinforcing rib 83 extends along a rear edge of the bottom 82. The left wall 84 and the right wall 85 extend upward from left and right side edges of the bottom 82, respectively. The front wall 86 extends upward from a front edge of the bottom 82. The bottom 82 has a curved shape so as to gently project downward. As illustrated in FIG. 6, the rear edge portion of the bottom 82 projects rearward in an arched shape in a plan view (a bottom surface-side view). The rear edge portion of the bottom 82 has an arched shape so as to extend along an inner peripheral edge of the first mounting recess portion 22 of the roof lining 20. The width dimension of the rear cover portion 81 is greater than the width dimension of the overhead console 40.

As illustrated in FIG. 9, the bottom 82 includes stopper pieces 87 that project rearward from an upper surface of the rear end portion. The two stopper pieces 87 are arranged in the vehicular width direction. The front portion 34 of the reinforcing member 30 includes stopper holes 35 that receive the stopper pieces 87, respectively. With the stopper pieces 87 being inserted in the stopper holes 35, respectively, the rear cover portion 81 is positioned with respect to the roof lining 20 (the reinforcing member 30) and fixed to the roof lining 20 (the reinforcing member 30) as illustrated in FIGS. 10 and 12.

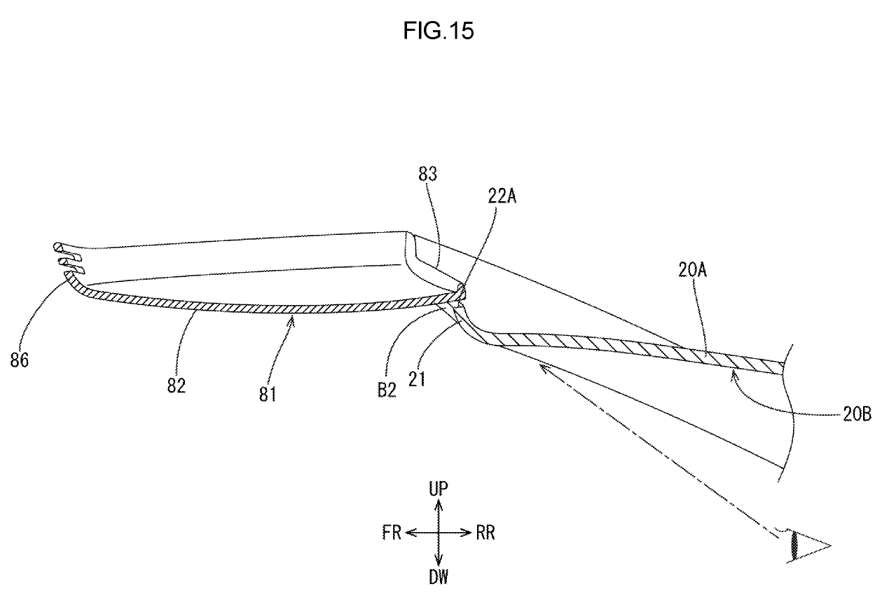

As illustrated in FIG. 4, the roof lining 20 includes the wall portion 21 at the front edge portion. The wall portion 21 extends upward and frontward at the front edge portion of the roof lining body 20A. The wall portion 21 is configured with being bent at the front edge of the roof lining body 20A. The wall portion 21 extends along the front edge of the roof lining 20 in the vehicular width direction. As illustrated in FIGS. 4 and 6, the first mounting recess portion 22 is recessed in an arched shape in the wall portion 21. As illustrated in FIG. 9, an edge surface 21A of the wall portion 21 faces upward. The first mounting recess portion 22 is a recessed portion recessed from the edge surface 21A of the wall portion 21 and having an arched shape. Therefore, as illustrated in FIG. 15, an inner peripheral edge surface 22A of the first mounting recess portion 22 that is recessed in the wall portion 21 also faces upward. The first mounting recess portion 22 is upper than the surface (the design surface 20B) of the roof lining 20. As illustrated in FIG. 15, the inner peripheral edge surface 22A of the first mounting recess portion 22 is upper than the surface (the design surface 20B) of the roof lining 20 and faces upward.

In this embodiment, as illustrated in FIG. 15, with the rear cover portion 81 being fixed to the roof lining 20 (the reinforcing member 30), the rear portion of the rear cover portion 81 is fitted in the first mounting recess portion 22 and the rear edge portion of the rear cover portion 81 overlaps the inner peripheral edge surface 22A of the first mounting recess portion 22 with respect to the upper-bottom direction. The inner peripheral edge surface 22A of the first mounting recess portion 22 overlaps the vehicular interior side surface (the lower surface) of the rear cover portion 81 and the inner peripheral edge surface 22A is opposite the vehicular interior side surface of the rear cover portion 81 in the upper-bottom direction. With such a configuration, as illustrated in FIG. 15, a border B2 of the roof lining 20 and the cover 80 is not directly seen by a passenger who is seated behind the front edge of the roof lining 20. Accordingly, design of the ceiling is improved.

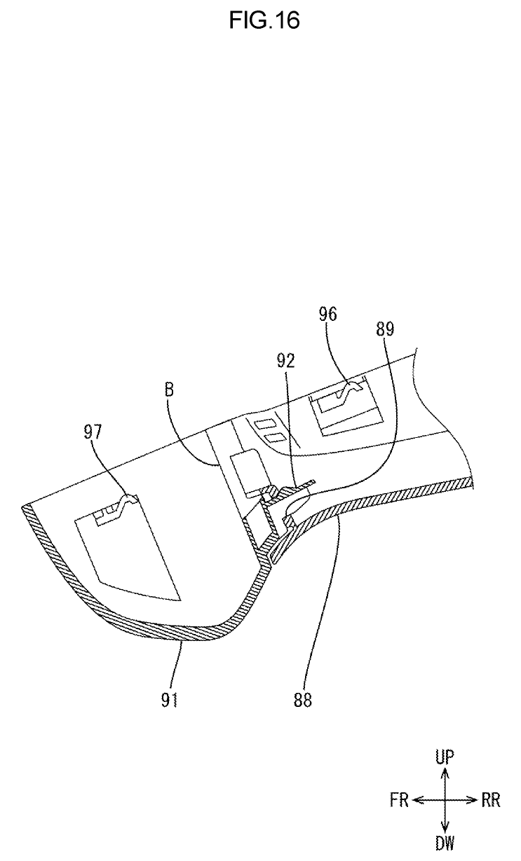

As illustrated in FIG. 9, the bottom 82 has a projecting portion 88 in a middle section thereof with respect to the vehicular width direction. The projection portion 88 gradually projects downward as it extends frontward. As illustrated in FIGS. 14 and 16, the front cover portion 91 is fitted to the rear cover portion 81 so as to be continuous to the front section of the projection portion 88. Specifically, the rear cover portion 81 includes two stopper holes 89 at a front edge of the projection portion 88. The front cover portion 91 includes stopper pieces 92 projecting from a rear end thereof. With the stopper pieces 92 being fitted in the stopper holes 89, respectively, the front cover portion 91 is positioned with respect to and fixed to the rear cover portion 81 as illustrated in FIGS. 10 and 16.

As illustrated in FIGS. 14 and 16, the front cover portion 91 has a curved shape so as to project downward and is continuous to the projection portion 88 of the rear cover portion 81. The width dimension of the front cover portion 91 measured in the vehicular width direction is smaller than the width dimension of the rear cover portion 81 measured in the vehicular width direction. Therefore, the rear cover portion 81 and the front cover portion 91 are connected and configured as the cover 80 having a T shape in a plan view (bottom surface view) as illustrated in FIG. 6.

With the rear cover portion 81 and the front cover portion 91 being fitted together, the upper edge surface of the rear cover portion 81 and the upper edge surface of the front cover portion 91 extend along the vehicular interior side surface of the front window 10 and are bonded to the vehicular interior side surface of the front window 10.

As illustrated in FIG. 9, the projection portion 88 of the rear cover portion 81 has a recessed portion 90 that is recessed rearward from the front edge of the rear cover portion 81. The recessed portion 90 is a semicircular recess. The front cover portion 91 has a recessed portion 93 that is recessed frontward from the rear edge of the front cover portion 91. The recessed portion 93 is a semicircular recess. With the front cover portion 91 and the rear cover portion 81 being fitted together, as illustrated in FIGS. 9 and 10, the recessed portions 90, 93 are connected and configured as a cover-side insertion hole 95 through which the neck portion 72 of the rear mirror 70 is inserted.

As illustrated in FIG. 14, the rear mirror 70 is arranged such that the neck portion 72 extends in the front-rear direction and the mirror body 73 is arranged behind the neck portion 72 with the rear mirror 70 being fixed to the front window 10. The connection portion 80C of the rear cover portion 81 and the front cover portion 91 is on the front side of the mirror body 73 of the rear mirror 70. Namely, the connection portion 80C is less likely to be seen by vehicle’s occupants.

The cover 80 of this embodiment is mounted on the roof lining 20 (the reinforcing member 30) as follows. First, the reinforcing member 30 is mounted in the recess 26 of the roof lining body 20A and the roof lining 20 is positioned with respect to the vehicle body. Then, the roof lining 20 is fixed to the vehicle body via the fixing portion 37 with a clip or a screw. Next, the front window 10 is positioned with respect to and fixed to the vehicle body. The camera module 50, the electric components 65, and the base portion 71 of the rear mirror 70 are fixed to predetermined positions of the vehicular interior side surface of the front window 10. Specifically, the upper surface of the camera holder 61, the upper end surfaces of the walls 55 of the AOV protection plate 53, the upper surface of the extending portion 56, and the portion of the upper surface of the holding member 60 are bonded to the predetermined portions of the front window 10. Thus, the camera module 50 is fixed to the front window 10. Then, lines are connected as appropriate.

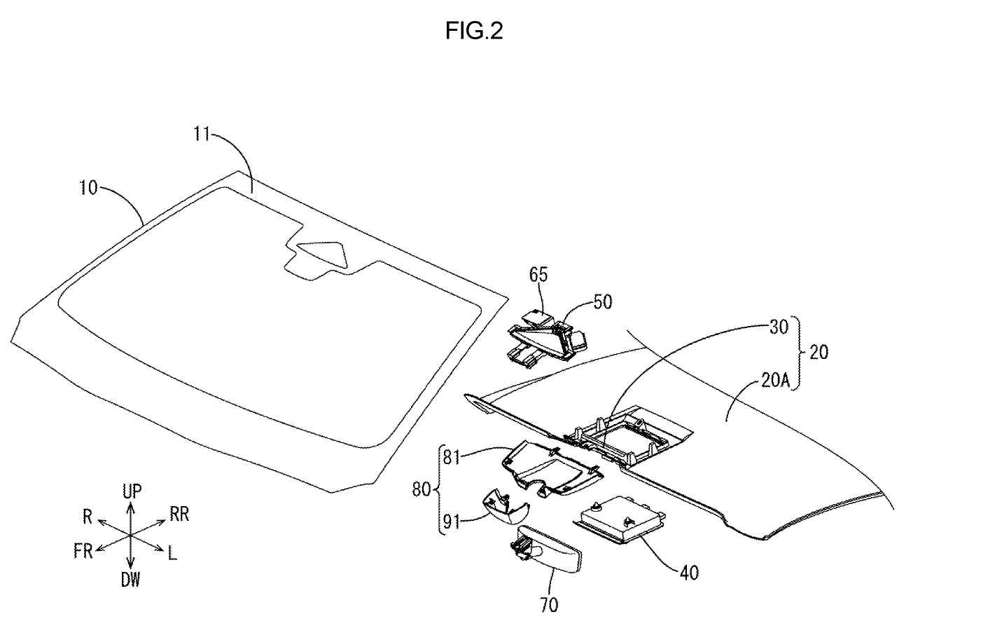

As illustrated in FIGS. 1 and 2, a window shield 11 is mounted on a portion of the front window 10 corresponding to the camera module 50 except for the AOV protection plate 53, a portion of the front window 10 corresponding to the base portion 71 of the rear mirror 70, and a peripheral edge portion of the front window 10. With the window shield 11, the camera module 50, the base portion 71, and the peripheral edge portion of the front window 10 (a border of the front window and other member) are not seen from the vehicular interior side.

Next, the rear cover portion 81 is moved from the front side toward the first mounting recess portion 22 and the stopper pieces 87 are inserted into the stopper holes 35 of the reinforcing member 30, respectively, through the space 22S of the first mounting recess portion 22. Thus, the rear cover portion 81 is attached to the roof lining 20. Accordingly, the rear portion of the rear cover portion 81 is fitted in the space 22S of the first mounting recess portion 22. Accordingly, the camera module 50 and the electric components 65 fixed to the front window 10 are covered by the rear cover portion 81 from the vehicular interior side and the rear portion of the rear cover portion 81 is arranged in the first mounting recess portion 22 of the roof lining 20 and the space 22S between the front window 10 and the reinforcing member 30 (the overhead console 40) is covered by the rear portion of the rear cover portion 81 (refer to FIG. 6).

In the mounting process of the rear cover portion 81, stopper pieces 96 that are on front sections of the left wall 84 and the right wall 85 (refer to FIG. 9) are pushed into the U-shaped cover holder 64 (refer to FIG. 13) of the holding member 60 of the camera module 50. Accordingly, the rear cover portion 81 is arranged in a correct position with respect to the camera module 50 and stably fixed.

The first mounting recess portion 22 is recessed in an arched shape in the wall portion 21 (the bent portion) that extends upward at the front edge portion of the roof lining body 20A. Therefore, the inner peripheral edge surface 22A of the arch-shaped first mounting recess portion 22 also faces upward and overlaps the rear cover portion 81 from the vehicular interior side as illustrated in FIG. 15 with the rear cover portion 81 being fixed to the roof lining 20. The rear cover portion 81 is slid rearward from the front side to be mounted on the roof lining 20. Therefore, the rear cover portion 81 is less likely to be contacted with the front edge of the roof lining 20 and the inner peripheral edge surface 22A of the first mounting recess portion 22.

Next, the neck portion 72 and the mirror body 73 that are joined together are moved closer to the base portion 71 that is fixed to the front window 10, and the neck portion 72 is inserted in the recessed portion 90 of the rear cover portion 81 and fitted to the base portion 71. The front cover portion 91 is moved toward the rear cover portion 81 from the front side and fitted to the rear cover portion 81 by inserting the stopper pieces 92 in the stopper holes 89 as illustrated in FIG. 16.

Stopper pieces 97 that are on the inner surfaces of the side walls of the front cover portion 91 (refer to FIG. 9) are pushed into a U-shaped cover holding portion 66 of the mirror fitting portion 63 of the holding member 60 of the camera module 50. Thus, the front cover portion 91 is arranged in a correct position with respect to the camera module 50 and stably fixed.

Lastly, the overhead console 40 is inserted in the space 25S of the second mounting recess portion 25 of the roof lining 20, in which the reinforcing member 30 is fitted, from the lower side and the overhead console 40 is fixed to the vehicle body with the clips 41. As illustrated in FIG. 12, the overhead console 40 includes flange portions 44 on the lower surface side of the side edges and the flange portions 44 project outwardly from the side edges, respectively. Components between the overhead console 40 and the roof lining 20 and components between the overhead console 40 and the cover 80 are covered by the flange portion 44 from the vehicular interior side as illustrated in FIG. 12. The second mounting recess portion 25 is farther away from the front edge of the roof lining 20 than the first mounting recess portion 22. The overhead console 40 that is in the second mounting recess portion 25 is away from the front edge of the roof lining 20. The first mounting recess portion 22 is at the front edge of the roof lining 20. With such a configuration, the space 22S of the first mounting recess portion 22 is between the overhead console 40 and the front window 10 without the cover 80 being fitted. With the rear cover portion 81 is fitted in the space 22S, the space 22S between the overhead console 40 and the front window 10 is closed.

The cover mounting assembly 1 according to this embodiment includes the cover 80 that covers a component attached to the vehicular interior side surface of the front window 10 of a vehicle and the roof lining 20 that is configured as the interior side surface of the ceiling of the vehicle and is arranged on the rear side of the front window 10. The overhead console 40 is arranged on the ceiling and away rearward from the front edge of the roof lining 20. The roof lining 20 includes the first mounting recess portion 22 that is recessed rearward from the front edge of the roof lining 20 rand the second mounting recess portion 25 that is recessed further rearward from the first mounting recess portion 22. The rear portion of the cover 80 is inserted in the first mounting recess portion 22 and mounted on the roof lining 20 with covering a space between the front window 10 and the overhead console 40.

According to the above configuration, the sense of unity and continuity of the cover 80 and the roof lining 20 is obtained and the design of the ceiling of a vehicle is improved compared to a configuration in which a cover and an overhead console that is disposed at a front edge of a roof lining are arranged adjacent to each other in the front-rear direction. In this embodiment, the cover 80 is mounted on the roof lining 20 and therefore, the relative arrangement of the cover 80 and the roof lining 20 is less likely to be changed and the sense of unity and continuity of the cover 80 and the roof lining 20 is further improved compared to a configuration in which a mounting position of a cover is determined with reference to the front window (a portion where a component is fixed).

The roof lining 20 includes the reinforcing member 30 that is disposed on the inner peripheral edge portion of the second mounting recess portion 25 on the vehicular exterior side of the roof lining body 20A. The frame-shaped reinforcing member 30 extends along the inner peripheral edge portion of the second mounting recess portion 25.

The reinforcing member 30 includes the front portion 34 that extends along a border B1 of the overhead console 40 and the cover 80. The cover 80 is attached to the front portion 34. With such a configuration, the cover 80 can be positioned correctly with respect to the overhead console 40. Therefore, the relative arrangement of the cover 80, the roof lining 20, and the overhead console 40 is less likely to be changed and the sense of unity is further improved.

The width of the cover 80 measured in the vehicular width dimension is greater than the width of the overhead console 40 measured in the vehicular width dimension. The mounting recessed portion 23 includes the first mounting recess portion 22 through which the rear portion of the cover 80 is inserted and the second mounting recess portion 25 that is narrower than the first mounting recess portion 22 and in which the overhead console 40 is fitted. The first mounting recess portion 22 is recessed in the wall portion 21 extending upward from the roof lining body 20A. Therefore, the inner peripheral edge surface 22A of the first mounting recess portion 22 facing upward overlaps the cover 80 from the vehicular interior side.

With multiple components being fixed to the front window 10, the width of the cover 80 measured in the vehicular width direction increases and is greater than the width dimension of the overhead console 40 measured in the vehicular width direction. Even in such a configuration, the border B2 of the roof lining 20 and the cover 80 is less likely to be seen by the vehicle’s occupants and therefore, the design of the ceiling is improved. Even with the size of the cover 80 increasing, good design can be obtained. Therefore, multiple small covers for each component are not necessary and the mounting steps and a manufacturing cost are less likely to increase.

The rear mirror 70 is fixed to the vehicular interior side surface of the front window 10. The rear mirror 70 includes the base portion 71 that is fixed to the front window 10 and the mirror body 73 that is a distal end section of the rear mirror 70 and connected to the base portion 71 via the neck portion 72. The cover 80 includes the front cover portion 91 and the rear cover portion 81 that are separable from each other in the front-rear direction. With the front cover portion 91 and the rear cover portion 81 being fitted together, the cover-side insertion hole 95 through which the neck portion 72 is inserted is formed. The connection portion 80C of the front cover portion 91 and the rear cover portion 81 is on the front side of the mirror body 73. With such a configuration, the connection portion 80C is less likely to be seen by the vehicle’s occupants and the appearance of the cover 80 is improved.

The reinforcing member 30 includes the projections 32A, 33A that are contacted with the roof panel 15. With the projections 32A, 33A being contacted with the roof panel 15, the roof lining 20 is less likely to be deformed upward and the rear portion of the cover 80 is fixed stably.

The reinforcing member 30 includes the fixing portion 37 for fixing the reinforcing member 30 to the roof panel 15. With such a configuration, the roof lining 20 is fixed to the roof panel 15 with a clip or a screw via the fixing portion 37 and the rear portion of the cover 80 is stably fixed.

According to this embodiment, the cover mounting assembly 1 that can achieve a sense of unity and continuity of the cover 80 and the roof lining 20 is provided.

### Other embodiments

The technology described herein is not limited to the embodiment described above with reference to the drawings. The technical scope of the present disclosure may include the following embodiments and all modifications in the scope of claim or its equivalent scope.

(1) In the above embodiment, the roof lining 20 includes the reinforcing member 30 that is attached to the roof lining body 20A; however, the roof lining 20 may integrally include a reinforcing member.

(2) In the above embodiment, the reinforcing member 30 (the reinforcing portion) has a frame shape and includes the front portion 34 (the bridging portion) and the cover 80 is connected to the front portion 34. A reinforcing portion may not include a bridging portion and a cover may be fixed to the inner edge portion of the mounting recessed portion.

(3) In the above embodiment, the width of the rear cover portion 81 is greater than the width of the overhead console 40; however, the width of a component cover may be same as or smaller than the width of an overhead console.

WHAT IS CLAIMED IS:

1. A cover mounting assembly comprising:
a cover covering a component that is on a front window of a vehicle; and
a roof lining disposed on a rear side of the front window and configured as a vehicular interior side surface of a ceiling of the vehicle, the roof lining including a mounting recessed portion that is recessed rearward from a front edge of the roof lining, the mounting recessed portion including
a first portion in which an overhead console is fitted such that the overhead console is disposed rearward away from the front edge of the roof lining, and
a second portion in which a rear portion of the cover is fitted to cover a space defined by the second portion between the front window and the overhead console and fix the cover to the roof lining.

2. The cover mounting assembly according to claim 1, wherein
the roof lining includes a reinforcing portion disposed along an inner peripheral edge portion of the first portion of the mounting recessed portion on a vehicular exterior side of the roof lining, and
the cover is attached to the reinforcing portion.

3. The cover mounting assembly according to claim 2, wherein
the reinforcing portion includes a bridging portion that extends along a border of the overhead console and the cover, and
the cover is fixed to the bridging portion.

4. The cover mounting assembly according to claim 1, wherein
the cover has a width that is measured in a vehicular width direction and is greater than a width of the overhead console measured in the vehicular width direction,
the mounting recessed portion includes the second portion in which the rear portion of the cover is fitted and the first portion in which the overhead console is fitted,
the first portion has a width that is smaller than a width of the second portion, and
the second portion has an inner peripheral edge surface that faces upward and overlaps the cover from a vehicular interior side.

5. The cover mounting assembly according to claim 1, further comprising a rear mirror mounted on the front window, the rear mirror including a base portion that is fixed to the front window, a neck portion, and a mirror body that is connected to the base portion via the neck portion, wherein
the cover includes a front cover portion and a rear cover portion that are fitted together in a front-rear direction to have an insertion hole through which the neck portion is inserted, and
the cover has a connection portion between the front cover portion and the rear cover portion and the connection portion is on a front side of the mirror body.

6. The cover mounting assembly according to claim 2, wherein the reinforcing portion includes a projection that is contacted with a roof panel.

7. The cover mounting assembly according to claim 2, wherein the reinforcing portion includes a fixing portion with which the reinforcing portion is fixed to a roof panel.

8. The cover mounting assembly according to claim 1, wherein the second portion of the mounting recessed portion is recessed from the front edge of the roof lining and the first portion is further recessed from the second portion and on a rear side of the second portion.

9. The cover mounting assembly according to claim 1, wherein
the roof lining includes a wall portion that extends upward at the front edge thereof, and
the second portion is a recess that is recessed in the wall portion.

10. The cover mounting assembly according to claim 9, wherein
the wall portion has an edge surface facing upward,
the second portion is a recessed portion recessed from the edge surface of the wall portion and having an arched shape, and
the second portion has an inner peripheral edge surface that faces upward and overlaps the rear portion of the cover.
